(19) United States
(12) Patent Application Publication
(10) Pub. No.: US 2016/0265840 A1
(43) Pub. Date: Sep. 15, 2016

(54) UNIT AND METHOD FOR PURIFYING CO2 BY ADSORPTION

(71) Applicant: L'Air Liquide, Societe Anonyme pour l'Etude et l'Exploitation des Procedes Georges Claude, Paris (FR)

(72) Inventor: Patrick LE BOT, VINCENNES (FR)

(73) Assignee: L'Air Liquide, Societe Anonyme pour l'Etude et l'Exploitation des Procedes Georges Claude, Paris (FR)

(21) Appl. No.: 15/034,110

(22) PCT Filed: Nov. 6, 2014
(86) PCT No.: PCT/FR2014/052842

§ 371 Date: May 3, 2016

(30) Foreign Application Priority Data
Nov. 6, 2013 (FR) 1360870

(51) Int. Cl. F25J 3/02; B01D 53/22; B01D 53/047

(52) U.S. Cl. CPC F25J 3/0266; B01D 53/047; B01D 53/229; F25J 3/0223; F25J 3/0261; F25J 3/0252; F25J 3/0233; B01D 2259/40009; B01D 2259/40054; B01D 2256/22; B01D 2257/502; B01D 2257/7025; B01D 2257/108; F25J 2205/40; F25J 2205/66; F25J 2205/80; F25J 2215/04; F25J 2220/82; F25J 2245/90

(57) ABSTRACT

The invention relates to a gas depleted of carbon dioxide produced by distillation, which is separated such as to produce a gas depleted of hydrogen, the gas depleted of hydrogen being used as a regeneration gas of a system for purification by adsorption upstream from the distillation, the composition of the regeneration gas at the intake of the purification system not being in the range of flammability in air.

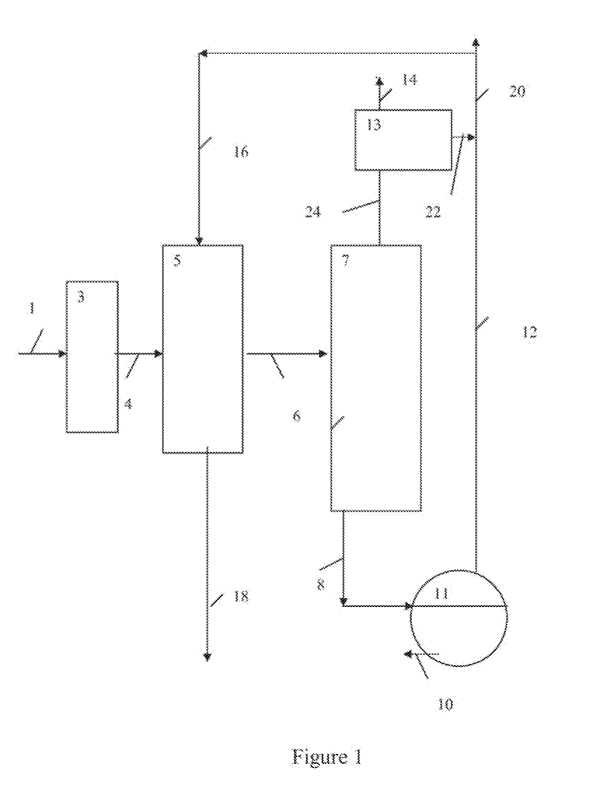

### CROSS REFERENCE TO RELATED APPLICATIONS

This application is a §371 of International PCT Application PCT/FR2014/052842, filed Nov. 6, 2014, which claims the benefit of FR1360870, filed Nov. 6, 2013, both of which are herein incorporated by reference in their entireties.

### TECHNICAL FIELD OF THE INVENTION

The present invention relates to a unit and to a process for purification of CO₂.

In particular, it relates to a unit for the purification of a gas mixture rich in CO₂, comprising hydrogen and water and also optionally carbon monoxide and/or methane.

### BACKGROUND OF THE INVENTION

A gas rich in CO₂ comprises at least 35 mol % of carbon dioxide, indeed even at least 65 mol % of carbon dioxide, on a dry basis.

The gas mixture preferably comprises at least 2000 ppm of hydrogen. It can also comprise at least 2000 ppm of carbon monoxide and/or at least 2000 ppm of methane.

All purities mentioned in this document are molar purities.

In one example, a unit for the purification of CO₂ treats a feed gas rich in CO₂, purifies it from certain undesirable constituents for a food application and liquefies it by evaporation of a heat-transfer fluid, generally ammonia.

Among the impurities present in the feed gas, some constituents are more volatile than CO₂ and are thus removed during the final distillation in an offgas.

This offgas is generally used as regeneration gas for a system for purification by adsorption (dryer) located upstream of the final distillation column.

When these volatile constituents are mainly H₂ and CO (indeed even CH₄), the regeneration gas, enriched in these constituents, enters the flammability range when brought into contact with the air, having been used for the regeneration of the purification system.

In this case, the offgas cannot be recycled in the feed gas as the recycling does not discharge the constituents and thus accumulates the flammable constituents.

It might be possible to envisage venting off this offgas, without using it for the regeneration in order to avoid the risks and additional costs (ATEX classification) related to the use of a flammable gas. The regeneration would then be carried out using pure CO₂ originating from the liquid output storage tank and consisting of the gas which is naturally formed above the surface of the liquid or, if not, from liquid deliberately evaporated.

In both cases, this configuration is damaging to the net production of the unit by a total amount equal to the flow necessary for the regeneration, i.e. of the order of 5 to 6%.

U.S. Pat. No. 4,952,223 describes a separation device upstream of an adsorption unit and downstream of a distillation column in order to modify the composition of the regeneration gas. The feed flow does not comprise hydrogen and the regeneration flow is not vented off and/or is not depleted in hydrogen.

WO07/126972 also describes a separation device, which is a phase separator, upstream of an adsorption unit and downstream of a distillation column but the composition values given in Table 1 do not correspond to the figure since the gas from the phase separator has to be depleted in CO₂, whereas the table shows the contrary. The teaching of this document is thus unclear.

### SUMMARY OF THE INVENTION

According to one subject matter of the invention, provision is made for a unit for the purification of CO₂ starting from a gas rich in CO₂ comprising at least 35 mol % of CO₂, hydrogen and water and also at least one, indeed even two, of the following impurities: carbon monoxide and methane, comprising:

i) at least one compressor for compressing the gas rich in CO₂ up to a first pressure P,

ii) at least one purification system capable of operating with a stage of adsorption at a pressure substantially equal to P and with a regeneration at a pressure of less than P in order to purify the gas at the first pressure originating from the at least one compressor in order to produce a gas purified at least in water,

iii) a system of columns comprising at least one distillation column capable of operating under a pressure substantially equal to P for the purified gas in order to produce a liquid enriched in CO₂ and depleted in hydrogen and optionally in carbon monoxide and/or in methane and a gas enriched in hydrogen and optionally in carbon monoxide and/or in methane and depleted in carbon dioxide,

iv) a separation device,

wherein the unit comprises a first pipe for sending the gas enriched in hydrogen and optionally in carbon monoxide and/or in methane and depleted in carbon dioxide from the system of columns to the separation device and a second pipe connected to the separation device in order to return a gas depleted in hydrogen and optionally in carbon monoxide and/or in methane, the second pipe being connected to the system for purification by adsorption in order to send there a regeneration gas consisting of either at least a portion of the gas depleted in hydrogen and optionally in carbon monoxide and/or in methane alone or at least a portion of the gas depleted in hydrogen and optionally in carbon monoxide and/or in methane mixed with another gas, and the purification system comprising means for venting off the regeneration gas which has been used for the regeneration.

According to other optional subject matters:
the separation device is a permeation device,
the composition of the gas depleted in hydrogen and optionally in CO generated by the separation device is not within the range of flammability in air,
the system of columns is positioned inside an isolated chamber and the separation device is outside any isolated chamber,
the unit comprises means for heating the gas depleted in carbon dioxide upstream of the separation device,
the means for heating the gas make possible an exchange of heat between the gas and ammonia and/or the gas rich in CO₂ at the first pressure,
the unit comprises a means for detecting the content of the gas enriched in hydrogen and optionally in carbon monoxide and/or in methane and depleted in carbon dioxide sent to the separation device,
the unit comprises a means for detecting the content of the gas depleted in hydrogen and optionally in carbon monoxide,
a detection means described above is connected to a means for closing the pipe for the gas depleted in hydrogen and optionally in carbon monoxide,
a detection means described above is connected to a means for opening the pipe for the other gas.

According to another subject matter of the invention, provision is made for a process for the purification of CO₂ starting from a gas rich in CO₂ comprising at least 35 mol % of CO₂, hydrogen and water and optionally of at least one, indeed even two, of the following impurities: carbon monoxide and methane, comprising at least the following stages:

i) the compression of the gas rich in CO₂ up to a first pressure P in order to produce a compressed gas rich in CO₂,

ii) the purification of the compressed gas rich in CO₂ in at least one system for purification by adsorption at a pressure substantially equal to P and regeneration at a pressure of less than P in order to produce a gas rich in CO₂ purified in water,

iii) distillation in a system of columns comprising at least one column for distillation under a pressure substantially equal to P of the purified gas in order to produce a liquid enriched in CO₂ and depleted in hydrogen and/or in carbon monoxide and/or in methane and a gas enriched in hydrogen and/or in carbon monoxide and/or in methane and depleted in carbon dioxide,

iv) a stage of separation in a separation device,

characterized in that the gas depleted in carbon dioxide is sent from the system of columns to the separation device, the separation device produces a gas depleted in hydrogen and optionally in carbon monoxide and/or in methane, the gas depleted in hydrogen and optionally in carbon monoxide and/or in methane, optionally mixed with another gas, is sent to the system for purification by adsorption in order to act as regeneration gas, and the regeneration gas which has been used for the regeneration is vented off, at least from time to time.

According to other optional aspects of the invention:
the hydrogen content of the regeneration gas at the inlet of the purification system being below a threshold corresponding to the range of flammability in air,
a flow of carbon dioxide gas, which can be derived from the liquid produced from the system of columns, is used to form a portion of the regeneration gas,
the flow of carbon dioxide is mixed with the gas depleted in hydrogen and optionally in carbon monoxide and/or in methane produced by the separation device in order to produce the regeneration gas,
the content of hydrogen and optionally of carbon monoxide and/or of methane is detected, either:

i) of the gas enriched in hydrogen and optionally in carbon monoxide and/or in methane and depleted in carbon dioxide from the system of columns or

ii) of the gas depleted in hydrogen and optionally in carbon monoxide and/or in methane produced by the separation device,

and, if the content or contents exceed(s) a given threshold, for example the limits of flammability in air, the gas depleted in hydrogen and optionally in carbon monoxide and/or in methane produced by the separation device is not used or carbon dioxide gas is mixed with the gas depleted in hydrogen and optionally in carbon monoxide and/or in methane produced by the separation device in order to act as regeneration gas,
the gas enriched in hydrogen and optionally in carbon monoxide and/or in methane and depleted in carbon dioxide sent to the separation device is flammable in air,
the gas enriched in hydrogen and optionally in carbon monoxide and/or in methane and depleted in carbon dioxide sent to the separation device comprises at least 5% of hydrogen, indeed at least even 10% of hydrogen,
the gas depleted in hydrogen and optionally in carbon monoxide and/or in methane originating from the separation device is flammable in air,
the content of the gas depleted in hydrogen and optionally in carbon monoxide is detected,
the pipe for the gas depleted in hydrogen and optionally in carbon monoxide is closed if the hydrogen content of the gas depleted in hydrogen is above a threshold,
the pipe for the other gas is opened if the hydrogen content of the gas depleted in hydrogen is above a threshold.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The Figure represents a process flow diagram in accordance with an embodiment of the present invention.

### DETAILED DESCRIPTION

The invention will be described in more detail with reference to the figure.

A gas 1 rich in CO₂ comprising at least 35% of CO₂, water, 10 000 ppm of H₂, 2000 ppm of CO and 2000 ppm of CH₄ has to be separated in order to produce a liquid enriched in carbon dioxide. The gas is compressed up to 20 bars a in a compressor 3 in order to produce a compressed gas 3. The compressed gas 3 is purified at 20 bars a in a purification unit 5 which operates by adsorption. The gas 6 purified in water is cooled (not illustrated) and sent to distillation in a system of columns 7 comprising at least one distillation column. The system produces a liquid enriched in carbon dioxide and depleted in carbon monoxide, in hydrogen and in methane, comprising at least 55% of carbon dioxide, 8, which is stored in a storage tank 11 and is sent as product 10 to a client.

The system of columns 7 also produces a gas 24 enriched in hydrogen, carbon monoxide and methane and depleted in carbon dioxide. The gas 24 comprises 15% of hydrogen, 3% of methane and 3% of carbon monoxide. The gas 24 comprises at least 5% of hydrogen, preferably at least 10% of hydrogen.

The invention provided has the aim of minimizing the losses related to the flammable compounds in the following way:

A separation device 13 which separates the CO₂ from the H₂, CO and methane, for example an HF membrane, separates the offgas 24. Under the effect of the difference in pressure between the offgas 24 (approximately 20 bars a) and atmospheric pressure, a portion of the flammable compounds is subjected to permeation and the membrane makes it possible to obtain:
a pressurized gas stream 22 depleted in H₂ and CO, which has become nonflammable and thus suited to being used for the regeneration,
a low-pressure gas stream 14 enriched in H₂ and CO, which is flammable and is vented off or flared off

The remaining regeneration gas 12 is withdrawn from the product storage tank 11.

The separation device 13, which can be a permeation device, can treat the offgas 24 at low temperature (at the outlet of the system of columns): the efficiency is low but the system is easy to install and the transportation of flammable gas is minimized. Preferably, the separation device 13 and the system of columns 7 are inside one and the same isolated chamber. In point of fact, the system of columns 7 can be positioned inside an isolated chamber while the separation device 13 is outside any isolated chamber.

The separation device 13, which can be a permeation device, can treat the offgas 24 at ambient or higher temperature, after reheating against a heat-transfer fluid (NH₃, gas 1 or 4, and the like). The efficiency of the permeation is good. For a permeation temperature of 40° C., 75% of recovery of CO₂ in the product is obtained when the gas 1 comprises less than 5% of hydrogen. In point of fact, this assumes transporting the flammable gas 24, which gives rises to costs.

It is possible to measure the content of carbon monoxide and/or of hydrogen and/or of methane of the gas 6, 24, 22 or 16 and to modify the amount of carbon dioxide 12 mixed with the gas 22 as a function of the content or contents observed. The richer the gas is in carbon monoxide and/or in hydrogen and/or in methane, the more necessary it is to re-add carbon dioxide to the regeneration gas in order to avoid discharging an explosive gas to the atmosphere.

The gas 20, 16 acts as regeneration gas for the purification device 5 and is subsequently discharged to the atmosphere as gas 18.

In this example, the gas 22 is nonflammable. It will be appreciated that the important point is that the gas 16, 20 is non-flammable. It is thus possible for the gas 22 to be flammable and for the fact of mixing it with the gas 12 to render it nonflammable.

According to an alternative form of the invention, the content of hydrogen and optionally of the carbon monoxide and/or of methane, either

i) of the gas enriched in hydrogen and optionally in carbon monoxide and/or in methane and depleted in carbon dioxide 24 from the system of columns or

ii) of the gas depleted in hydrogen and optionally in carbon monoxide and/or in methane 22 produced by the separation device,

is detected.

If the content or contents of the gases 22, 24 or of one of these gases exceed(s) the limits of flammability in air, in some cases, the gas depleted in hydrogen and optionally in carbon monoxide and/or in methane produced by the separation device is not used as regeneration gas.

In this case, depending on the content or contents, the gas 12 unmixed with the gas 22 can be used as regeneration gas 16. In other cases, depending on the content or contents, carbon dioxide gas 12 is mixed with the gas depleted in hydrogen and/or in carbon monoxide and/or in methane 22 produced by the separation device 13 in order to act as regeneration gas 16.

The carbon dioxide, in both cases, does not necessarily originate from the storage tank 11 but may originate from an external source. Likewise, another gas can replace the gas 16.

The unit can comprise at least one means for detecting the content or contents of the gases 22 and/or 24 connected to a means for closing the pipe for the gas 22 and/or to a means for opening the pipe for the gas 12.

### EXAMPLE

The gas 6 (feed gas after drying in the purification system) comprises: 98.5% CO₂, 1% (10 000 ppm) methane, 0.2% (2000 ppm) H₂, 0.2% (2000 ppm) CO and 0.1% inert materials (N₂+O₂)

The gas 24 comprises 78% CO₂, 15% H₂, 3% CO, 3% CH₄ and 1% inert materials (N₂+O₂)

The gas 22 comprises 93% CO₂, 5% H₂ and 1.5% CH₄.

After dilution with pure CO₂ 12, the gas 20, 16 comprises 96.7% CO₂, 2.5% H₂ and 0.8% CH₄.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A unit for the purification of CO₂ starting from a gas rich in CO₂ comprising at least 35 mol % of CO₂, hydrogen and water and an impurity selected from the group consisting of carbon monoxide, methane, and combinations thereof, the unit comprising:
i) at least one purification system configured to operate with a stage of adsorption at a pressure substantially equal to a first pressure P₁ and with a regeneration at a pressure of less than the first pressure P₁ in order to purify the gas at the first pressure P₁ originating from an at least one compressor in order to produce a gas purified at least in water;
ii) a system of columns comprising at least one distillation column configured to operate under a pressure substantially equal to P₁ for the purified gas in order to produce a liquid enriched in CO₂ and depleted in hydrogen and the impurity and a gas enriched in hydrogen and the impurity and depleted in carbon dioxide;
iii) a separation device;
iv) a first pipe configured to send the gas enriched in hydrogen and the impurity and depleted in carbon dioxide from the system of columns to the separation device; and
v) a second pipe connected to the separation device configured to put out a gas depleted in hydrogen and the impurity, the second pipe being connected to the system for purification by adsorption in order to send there a regeneration gas consisting of either at least a portion of the gas depleted in hydrogen and the impurity or at least a portion of the gas depleted in hydrogen and the impurity mixed with another gas,
wherein the purification system comprises means for venting off the regeneration gas which has been used for the regeneration.

17. The unit as claimed in claim 16, in which the separation device is a permeation device.

18. The unit as claimed in claim 16, in which the composition of the gas depleted in hydrogen and optionally in CO and/or in methane generated by the separation device is not within the range of flammability in air.

19. The unit as claimed in claim 16, in which the system of columns is positioned inside an isolated chamber and the separation device is outside any isolated chamber.

20. The unit as claimed in claim 16, comprising means for heating the gas depleted in carbon dioxide upstream of the separation device.

21. The unit as claimed in claim 20, in which the means for heating the gas make possible an exchange of heat between the gas and ammonia and/or the gas rich in CO₂ at the first pressure.

22. A process for the purification of CO₂ starting from a gas rich in CO₂ comprising at least 35 mol % of CO₂, hydrogen and water and optionally of at least one of the, indeed even both, following impurities: carbon monoxide and methane, comprising at least the following stages:
i) the compression of the gas rich in CO₂ up to a first pressure P in order to produce a compressed gas rich in CO₂;
ii) the purification of the compressed gas rich in CO₂ in at least one system for purification by adsorption at a pressure substantially equal to P and regeneration at a pressure of less than P in order to produce a gas rich in CO₂ purified in water;
iii) distillation in a system of columns comprising at least one column for distillation under a pressure substantially equal to P of the purified gas in order to produce a liquid enriched in CO₂ and depleted in hydrogen and/or in carbon monoxide and/or in methane and a gas enriched in hydrogen and/or in carbon monoxide and/or in methane and depleted in carbon dioxide,
iv) a stage of separation in a separation device;
characterized in that the gas depleted in carbon dioxide is sent from the system of columns to the separation device, the separation device produces a gas depleted in hydrogen and optionally in carbon monoxide and/or in methane, the gas depleted in hydrogen and optionally in carbon monoxide and/or in methane, optionally mixed with another gas, is sent to the system for purification by adsorption in order to act as regeneration gas, and the regeneration gas which has been used for the regeneration is vented off, at least from time to time.

23. The unit as claimed in claim 22, in which the hydrogen content of the regeneration gas at the inlet of the purification system being below a threshold corresponding to the range of flammability in air.

24. The unit as claimed in claim 22, in which a flow of carbon dioxide gas, which can be derived from the liquid produced from the system of columns, is used to form a portion of the regeneration gas.

25. The unit as claimed in claim 22, in which the flow of carbon dioxide is mixed with the gas depleted in hydrogen and optionally in carbon monoxide and/or in methane produced by the separation device in order to produce the regeneration gas.

26. The unit as claimed in claim 22, in which the content of hydrogen and optionally of carbon monoxide and/or of methane is detected, either
i) of the gas enriched in hydrogen and optionally in carbon monoxide and/or in methane and depleted in carbon dioxide from the system of columns or
ii) of the gas depleted in hydrogen and optionally in carbon monoxide and/or in methane produced by the separation device,
and, if the content or contents exceed(s) a threshold or thresholds corresponding to the limits of flammability in air, the gas depleted in hydrogen and optionally in carbon monoxide and/or in methane produced by the separation device is not used as regeneration gas or carbon dioxide gas is mixed with the gas depleted in hydrogen and optionally in carbon monoxide and/or in methane produced by the separation device in order to act as regeneration gas.

27. The unit as claimed in claim 22, in which the gas enriched in hydrogen and optionally in carbon monoxide and/or in methane and depleted in carbon dioxide sent to the separation device comprises at least 5% of hydrogen, indeed even at least 10% of hydrogen.

28. The unit as claimed in claim 22, in which the content of the gas depleted in hydrogen and optionally in carbon monoxide is detected.

29. The unit as claimed in claim 22, in which the pipe for the gas depleted in hydrogen and optionally in carbon monoxide is closed if the hydrogen content of the gas depleted in hydrogen is above a threshold.

30. The unit as claimed in claim 22, in which the pipe for the other gas is opened if the hydrogen content of the gas depleted in hydrogen is above a threshold.
